(19) United States
(12) Patent Application Publication
(10) Pub. No.: US 2022/0117207 A1
(43) Pub. Date: Apr. 21, 2022

(54) TOP WATER FISHING LURE APPARATUS

(71) Applicant: BassGangsta LLC, Austell, GA (US)

(72) Inventor: Adam Slupczynski, Austell, GA (US)

(21) Appl. No.: 17/503,185

(22) Filed: Oct. 15, 2021

Related U.S. Application Data
(60) Provisional application No. 63/092,011, filed on Oct. 15, 2020.

(51) Int. Cl. A01K 85/12

(52) U.S. Cl. CPC A01K 85/12

(57) ABSTRACT

The present disclosure provides top water fishing lure apparatus comprising: a generally heart-shaped blade; and a wire comprising: a top segment comprising a wire cap, a middle segment disposed between the top segment and a bottom segment, and a bottom segment comprising: a flexible curved portion disposed at a first distal end of the bottom segment and shaped such that a bell, in an “off” position, is secured within the flexible curved portion, a hook assembly disposed at a second distal end of the bottom segment, and a bell disposed, while in an “on” position, between the flexible curved portion and the hook assembly, the bell comprising a bell aperture allowing translational movement of the bell along the length of the bottom segment, wherein in the “on” position, the blade is configured to contact the bell during a rotation of the blade.

### RELATED APPLICATION

Under provisions of 35 U.S.C. § 119(e), the Applicant claims benefit of U.S. Provisional Application No. 63/092,011 filed on Oct. 15, 2020, and having inventors in common, which is incorporated herein by reference in its entirety.

It is intended that the referenced application may be applicable to the concepts and embodiments disclosed herein, even if such concepts and embodiments are disclosed in the referenced application with different limitations and configurations and described using different examples and terminology.

### FIELD OF DISCLOSURE

The present disclosure generally relates to fishing lures.

### BACKGROUND

In some situations, when fishing, lures that resemble insects, small birds, injured fish, frogs, or small lizards, may catch more fish. For example, a buzzbait lure employs a strategy of utilizing a buzzbait blade, which, when reeled in, keeps the lure near the surface of the water and simultaneously vibrates, with a trailer attached slightly underwater. Thus, the conventional strategy is to employ the buzzbait near banks and undergrowth to simulate an insect which may be attractive to the fish in the area. This often causes problems because the conventional strategy does not account for when fish attempt to bite the trailer, and the blade prevents the fish from getting caught on the hook located in the trailer. A buzzbait lure with an ability to move the blade away from the trailer/hook combination when a fish strikes is needed.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

In one aspect, embodiments of the present disclosure may provide a top water fishing lure apparatus comprising: a generally heart-shaped blade comprising: a generally rectangular portion defining a planar surface, the planar surface comprising at least one wire connecting portion, a first rounded portion disposed on a first side of the generally rectangular portion, a second rounded portion disposed on a second side of the generally rectangular portion, and a corner opposite the first rounded portion and the second rounded portion, the corner being curved orthogonally from the planar surface of the blade, wherein the first rounded portion curves orthogonally from the planar surface, wherein the second rounded portion curves orthogonally from the planar surface and opposite from the first rounded portion, wherein the blade is configured to secure to a top segment of a blade-bell wire via a wire securing portion; the blade-bell wire comprising: the top segment comprising a wire cap secured on a distal end of the top segment, the wire cap being configured to prevent linear translation of the blade, a bottom segment comprising: a bell secured on the bottom segment via a bell aperture, a ball secured on the bottom segment via a ball aperture, and a clamp on a distal end of the bottom segment, and a securing segment disposed between the top segment and the bottom segment; a sleeve securing to the following: the securing segment of the blade-bell wire, and a top bait wire segment, wherein the top segment is oriented above the sleeve, wherein the bottom segment is oriented below the sleeve; and a bait module comprising a bait wire comprising: the top bait wire segment secured to the sleeve on a distal end of the top bait wire segment, a bottom bait wire segment comprising a hook assembly, wherein the bait wire is oriented such that the hook assembly does not contact the blade.

In another aspect, embodiments of the present disclosure may provide a top water fishing lure apparatus comprising: a generally heart-shaped blade comprising: a generally rectangular portion defining a planar surface, the planar surface comprising at least one wire connecting portion, a first rounded portion disposed on a first side of the generally rectangular portion, a second rounded portion disposed on a second side of the generally rectangular portion, and a corner opposite the first rounded portion and the second rounded portion, the corner being curved orthogonally from the planar surface of the blade, wherein the first rounded portion curves orthogonally from the planar surface, wherein the second rounded portion curves orthogonally from the planar surface and opposite from the first rounded portion, wherein the blade is configured to secure to a top segment of a blade wire via a wire securing portion; the blade wire comprising: the top segment comprising a wire cap secured on a first distal end of the top segment, the wire cap being configured to prevent linear translation of the blade, and a securing segment oriented at a generally ninety-degree angle from the top segment; a sleeve securing to the following: the securing segment of the blade wire, and a top hook module wire, wherein the top segment is oriented above the sleeve; and a bait module comprising: a bait wire comprising: a top bait wire segment secured to the sleeve on a distal end of the top bait wire segment, a bottom bait wire segment comprising: a flexible curved portion disposed at a first distal end of the bottom bait wire segment and shaped such that a bell, in an “off” position, is secured within the flexible curved portion, a hook assembly disposed at a second distal end of the bottom bait wire segment, and the bell disposed, while in an “on” position, between the flexible curved portion and the hook assembly, the bell comprising a bell aperture allowing translational movement of the bell along the length of the bottom bait wire segment, wherein in the “on” position, the blade is configured to contact the bell during a rotation of the blade.

In another aspect, embodiments of the present disclosure may provide a top water fishing lure apparatus comprising: a generally heart-shaped blade comprising: a generally rectangular portion defining a planar surface, the planar surface comprising at least one wire connecting portion, a first rounded portion disposed on a first side of the generally rectangular portion, a second rounded portion disposed on a second side of the generally rectangular portion, and a corner opposite the first rounded portion and the second rounded portion, the corner being curved orthogonally from the planar surface of the blade, wherein the first rounded portion curves orthogonally from the planar surface, wherein the second rounded portion curves orthogonally from the planar surface and opposite from the first rounded portion, wherein the blade is configured to secure to a top segment of a wire via a wire securing portion; and the wire comprising: the top segment comprising a wire cap secured on a first distal end of the top segment, the wire cap being configured to prevent linear translation of the blade along the length of the top segment, a middle segment disposed between the top segment and a bottom segment, and the bottom segment comprising: a flexible curved portion disposed at a first distal end of the bottom segment and shaped such that a bell, in an “off” position, is secured within the flexible curved portion, a hook assembly disposed at a second distal end of the bottom segment, and the bell disposed, while in an “on” position, between the flexible curved portion and the hook assembly, the bell comprising a bell aperture allowing translational movement of the bell along the length of the bottom segment, wherein in the “on” position, the blade is configured to contact the bell during a rotation of the blade.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1A is a perspective view of a first embodiment of a top water fishing lure apparatus 100;

FIG. 1B is another perspective view thereof;

FIG. 1C is a side view of the top water fishing lure apparatus 100 in an “on” position;

FIG. 1D is a side view of the top water fishing lure apparatus 100 in an “off” position;

FIG. 2A is a perspective view of second embodiment of the top water fishing lure apparatus 100;

FIG. 2B is another perspective view thereof;

FIG. 2C is a side view of the top water fishing lure apparatus 100 in an “on” position;

FIG. 2D is a side view of the top water fishing lure apparatus 100 in an “off” position;

FIG. 3A is a perspective view of third embodiment of the top water fishing lure apparatus 100;

FIG. 3B is another perspective view thereof;

FIG. 3C is a side view of the top water fishing lure apparatus 100 in an “on” position;

FIG. 3D is a side view of the top water fishing lure apparatus 100 in an “off” position;

FIG. 4A is a perspective view of fourth embodiment of the top water fishing lure apparatus 100;

FIG. 4B is another perspective view thereof;

FIG. 4C is a side view of the top water fishing lure apparatus 100 in an “on” position;

FIG. 4D is a side view of the top water fishing lure apparatus 100 in an “off” position;

FIG. 5A is a perspective view of fifth embodiment of the top water fishing lure apparatus 100;

FIG. 5B is another perspective view thereof;

FIG. 5C is a side view of the top water fishing lure apparatus 100 in an “on” position;

FIG. 5D is a side view of the top water fishing lure apparatus 100 in an “off” position;

FIG. 6A is a perspective view of sixth embodiment of the top water fishing lure apparatus 100;

FIG. 6B is another perspective view thereof;

FIG. 6C is a top view thereof;

FIG. 6D is a side view thereof;

FIG. 6E is another side view thereof;

FIG. 7A is a perspective view of a first embodiment of a hook module 520;

FIG. 7B is a side view thereof;

FIG. 7C is a front view thereof;

FIG. 8A is a perspective view of a second embodiment of the hook module 520;

FIG. 8B is a side view thereof;

FIG. 8C is a front view thereof;

FIG. 9 is a flow chart of a method for providing a top water fishing lure apparatus;

FIG. 10 is a flow chart of a method for replacing a sleeve with a spring;

FIG. 11 is a flow chart of a method for changing a single blade module to a double blade module on a top water fishing lure apparatus; and

FIG. 12 is a flow chart of a method for casting and reeling a top water fishing lure apparatus.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of fishing lures, embodiments of the present disclosure are not limited to use only in this context.

### I. Apparatus Overview

This overview is provided to introduce a selection of concepts in a simplified form that are further described below. This overview is not intended to identify key features or essential features of the claimed subject matter. Nor is this overview intended to be used to limit the claimed subject matter's scope.

Fish tend to strike lures from the side pushing the lure away from its mouth. Lures with non-pivotable spinning blades can get in the way and prevent a fish from getting caught on the hook of the lure, thereby reducing the chance of catching the fish.

The present fishing lure apparatus provides a swinging spinning blade that moves to the side as a fish strikes, making it easier for the fish to catch the bait and increase the hook-up ratio. The spinning blade hits the clicker, the bell and ball below the blade, making a clicking noise. The clicker may be designed with a small bell over a ball that moves with blade. The bell and ball may provide more tolerance in movement to click without stopping the blade. The wire on the bottom of the blade may be shaped similar to a clamp to allow clicker to be pulled forward to turn off and pushed backwards to turn on the clicking sounds as the blade rotates in the water on fishing line, attracting fish with the created sound. The indented holes on the blade may create a popping noise and bubbles from trapped air and creates more lift on the lure. Fish may be attracted to the sound, splash and reflection from the blade. The wire secured with sleeve may be inside of the blade to prevent the line from catching the wire and debris in the water. When the bait is pulled on the line in the water, the spinning blade and the shape of the head may lift the lure on the surface of the water.

Embodiments of the present disclosure may comprise methods, systems, and components comprising, but not limited to, at least one of the following:
a. A Blade Module 200;
b. A Blade-Bell Wire Module 300;
c. A Sleeve Module 400;
d. A Bait Module 500; and

In some embodiments, the present disclosure may provide an additional set of components for further facilitating the system. The additional set of components may comprise, but not be limited to:
e. A Double Blade Module 600.

Details with regards to each component is provided below. Although components are disclosed with specific functionality, it should be understood that functionality may be shared between components, with some functions split between components, while other functions duplicated by the components. Furthermore, the name of the component should not be construed as limiting upon the functionality of the component. Moreover, each stage disclosed within each component can be considered independently without the context of the other stages within the same component or different components. Each stage may contain language defined in other portions of this specifications. Each stage disclosed for one component may be mixed with the operational stages of another component. In the present disclosure, each stage can be claimed on its own and/or interchangeably with other stages of other components.

The following depicts an example of a method of a plurality of methods that may be performed by at least one of the aforementioned components. Various hardware components may be used at the various stages of operations disclosed with reference to each component. For example, although methods may be described to be performed by a single apparatus, it should be understood that, in some embodiments, different operations may be performed by different apparatuses in operating in conjunction with each other. For example, the sleeve module, the hook module, and/or the blade module may be employed in the performance of some or all of the stages disclosed with regard to the methods. Similarly, one apparatus may be employed in the performance of some or all of the stages of the methods. As such, the apparatus may comprise at least one of the architectural components disclosed herein.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed without altering or deterring from the fundamental scope of the depicted methods and systems disclosed herein.

Consistent with embodiments of the present disclosure, a method may be performed by at least one of the aforementioned components. The method may comprise the following stages:
providing a blade module 200 comprising:
   providing a first rounded edge 205,
   providing a second rounded edge 210,
   providing a first straight edge 240,
   providing a second straight edge 245,
   connecting one end of the first straight edge 240 to one end of the second straight edge 245, creating a corner 250,
      wherein the corner 250 comprises an aperture 255,
   forming a planar surface by connecting the first rounded edge 205, the second
   rounded edge 210, the first straight edge 240, and the second straight edge 245,
   curving the corner 250 perpendicularly to the planar surface 215,
   providing at least one planar surface protrusion 225,
   providing a securing protrusion 230, and
   providing a rivet sleeve 235, wherein the rivet sleeve does not stick out beyond blade and the wire does not extend beyond rivet sleeve.
providing a blade-bell wire module 300 comprising:
   providing a blade bell wire 305, wherein the blade bell wire 305 comprises:
      providing a top segment 310, and
      providing a bottom segment 315,
connecting the top segment 310 to the securing protrusion 230,
connecting a wire cap 320 to a portion of the top segment 310 protruding from the securing protrusion 230,
guiding the top segment 310 to through the aperture 255 of the corner 250,
providing a sleeve module 400, comprising providing a sleeve 400, wherein the sleeve 400 comprises:
   providing a top aperture, and
   providing a bottom aperture,
connecting the top segment 310 to the top aperture;
connecting the bottom segment 315 to the bottom aperture;
providing a ball, wherein the ball comprises a ball aperture;
connecting the ball to the bottom segment 315 through the bell aperture;
providing a bell, wherein the bell comprises a bell aperture;
connecting the ball to the bottom segment 315 through the bell aperture;
connecting a clamp to the end of the bottom segment 315;
providing a bait module 500 comprising:
   providing a bait wire 505,
   providing an top bait wire segment 510,
   connecting the top bait wire segment 510 to the sleeve 400,
   providing a bottom bait wire segment 515,
   connecting the bottom bait wire segment 515 to the sleeve 400;
   providing a head housing 535,
   connecting the head housing 535 to the distal end below the bottom bait wire segment 515,
   connecting a hook 550 to the head housing 535,
   connecting a trailer keeper 560 to the head housing 535, and
   connecting a skirt to the head housing 535.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

It should be noted that any ball, clamp, and/or any other type of securing means may be alternately embodied as, for example:
i. a bolt,
ii. a bead,
iii. a nut,
iv. a screw,
v. a rivet,
vi. a fastener,
vii. a latch,
viii. a coupling,
ix. a lock, and/or
x. a catch.

It should be further noted that any wire may be alternately embodied as, for example:
i. a cable,
ii. a strand,
iii. a coil,
iv. a thread,
v. a rope,
vi. a cord,
vii. a lace,
viii. a string, and
ix. a stay.

### II. Apparatus Configuration

Embodiments of the present disclosure provide a top water fishing lure apparatus comprised of a distributed set of components, including, but not limited to:
a. Blade Module 200

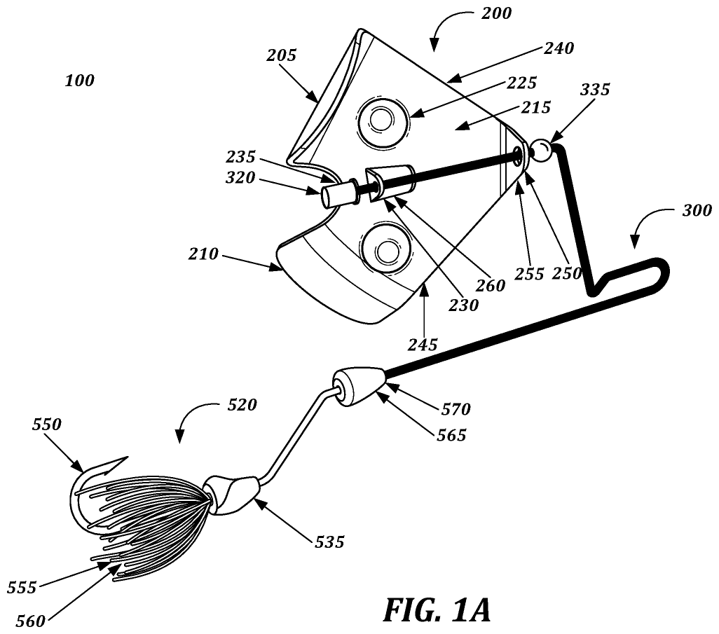

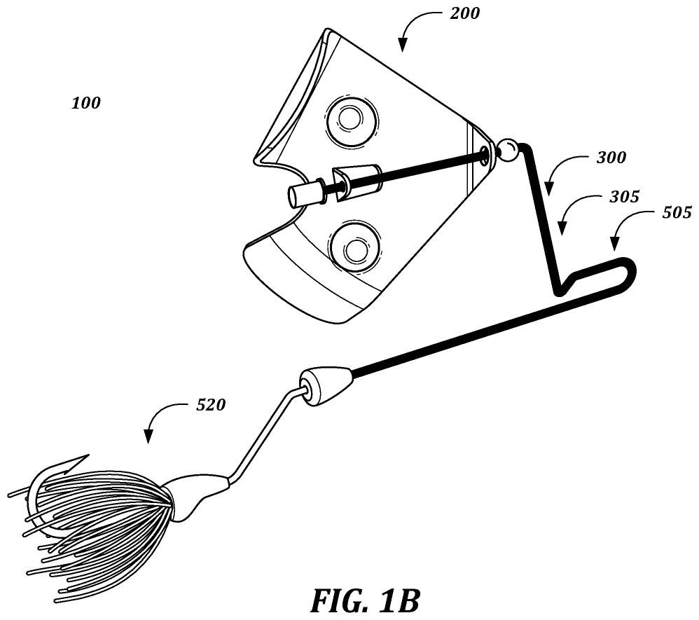

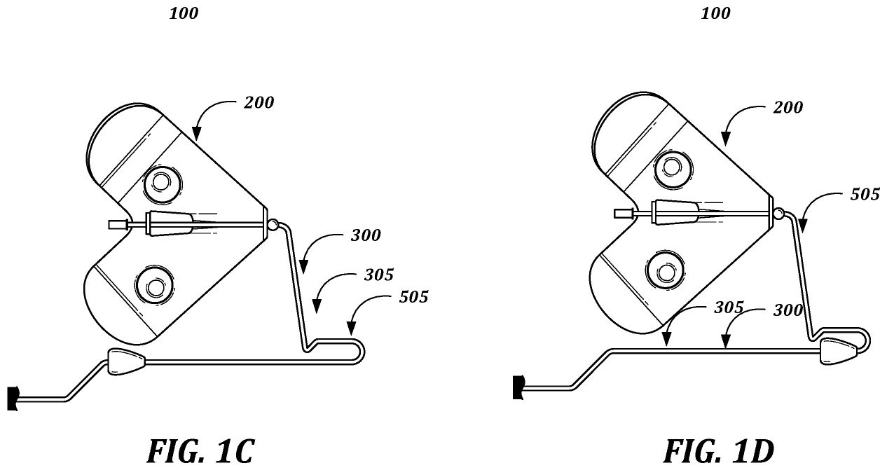

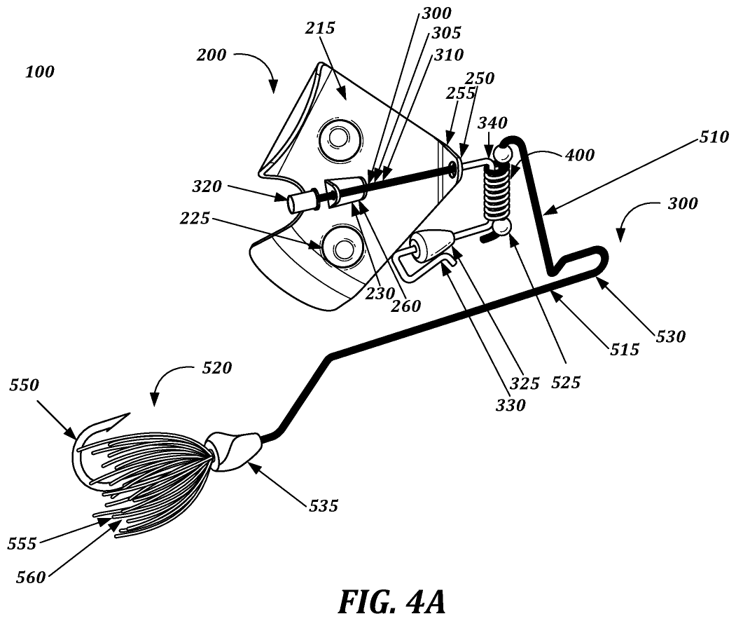

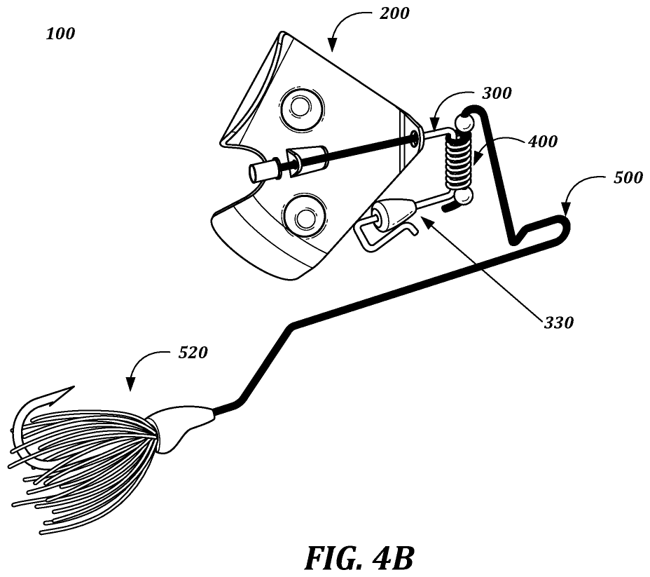

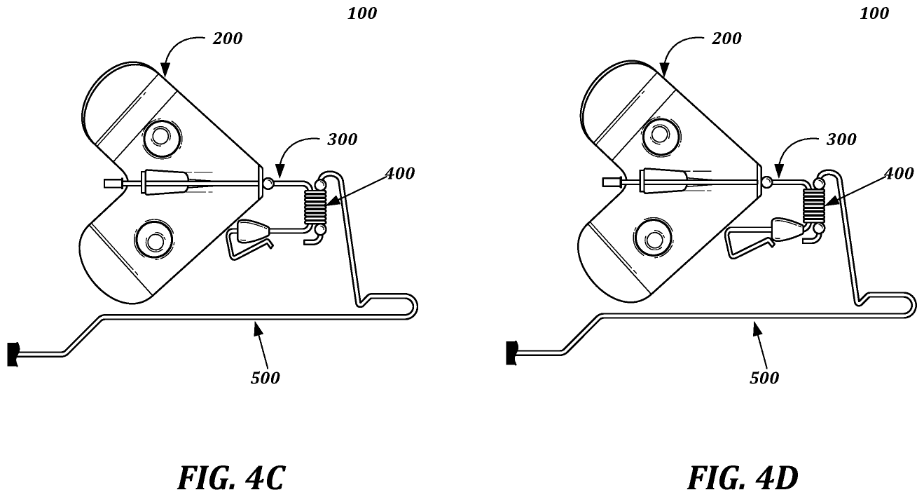

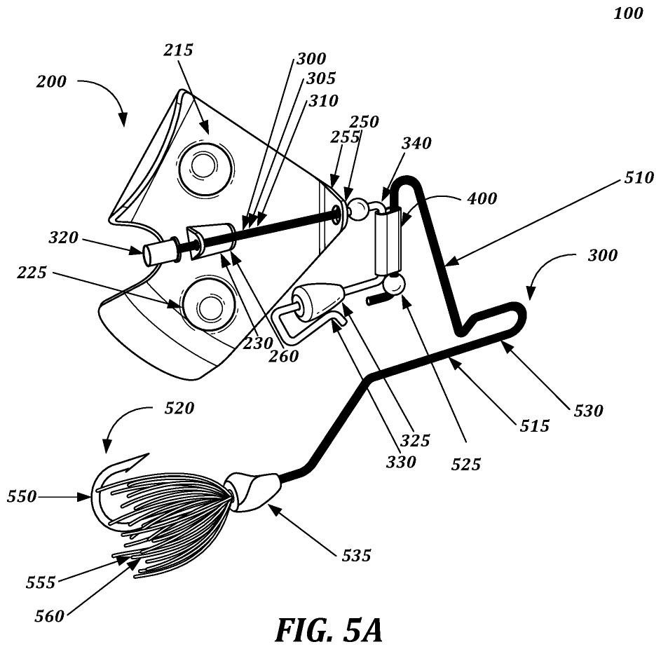

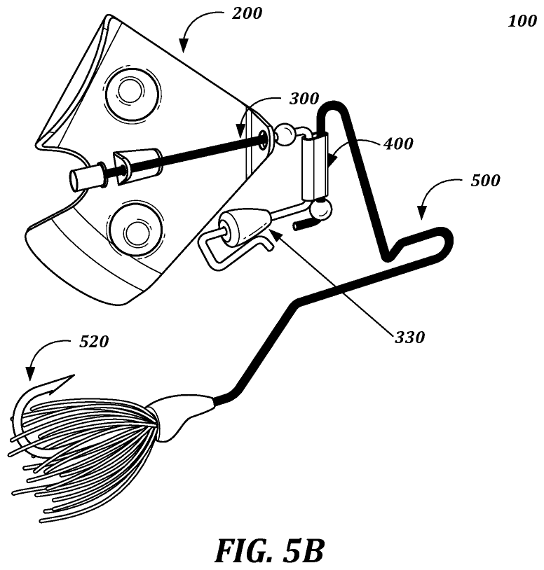

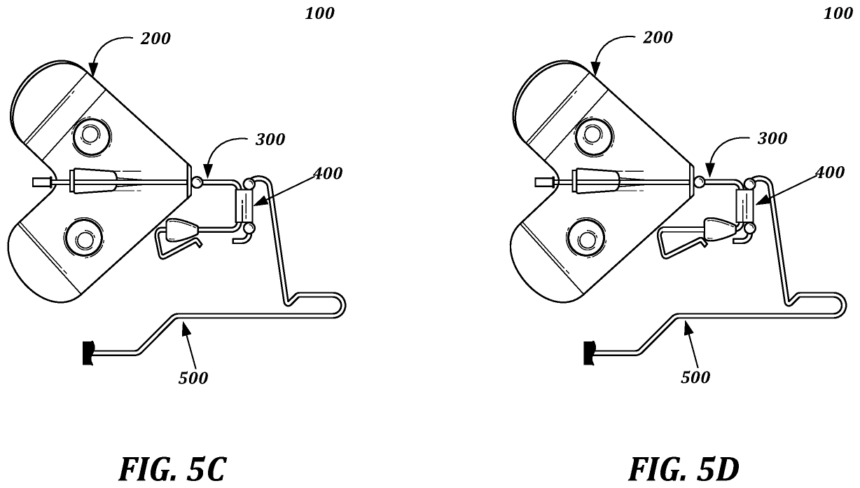

FIGS. 1A-5D illustrates blade module (used interchangeably with “Blade”) 200 consistent with embodiments of the disclosure. In some embodiments, the blade module 200 may comprise a first rounded edge 205, illustrated at least in FIGS. 1A, 2A, 3A, 4A, and 5A. In further embodiments, blade module 200 may comprise a second rounded edge 210, illustrated at least in FIGS. 1A, 2A, 3A, 4A, and 5A. In some embodiments, the first rounded edge 205 and/or the second rounded edge 210 may comprise various shapes, sizes, and configurations.

In other embodiments, the blade module 200 may be generally heart-shaped including a generally rectangular portion, the a first rounded edge 205, and the second rounded edge 210. The generally rectangular portion may define a planar surface 215, illustrated at least in FIGS. 1A, 2A, 3A, 4A, and 5A. The first rounded edge 205 and/or the second rounded edge 210 may be attached and/or disposed on a first side and/or a second side of the rectangular portion at an angle relative to the planar surface 215.

In some embodiments, the planar surface may comprise at least one planar surface aperture 220, illustrated at least in FIGS. 1A, 2A, 3A, 4A, and 5A. In even further embodiments, blade module 200 may comprise at least one planar surface protrusion 225, illustrated at least in FIGS. 1A, 2A, 3A, 4A, and 5A. By way of nonlimiting example, the at least one planar surface protrusion 225 may be an indentation. By way of nonlimiting example, the at least one planar surface protrusion 225 may create a popping noise and may create more lift on apparatus 100 as it is reeled in. In still further embodiments, blade module 200 may comprise at least one securing protrusion 230, illustrated at least in FIGS. 1A, 2A, 3A, 4A, and 5A. The at least one securing protrusion 230 may be used to thread and/or secure a connecting wire. In still further embodiments, blade module 200 may comprise a rivet sleeve 235, illustrated at least in FIG. 1A. In some embodiments, the rivet sleeve 235 may extend ³A to end of the blade module 200, not to extend beyond the blade module 235, while the wire is clamped inside of the blade module 200, instead of being bent behind the rivet sleeve 235, as seen in a majority of other blades. The rivet sleeve 235 may be used to prevent a fishing line from being caught on the bait. The rivet sleeve 235 may be further used to prevent any bait from catching and/or holding unwanted weeds or debris. The rivet sleeve may be housed in a wire cap 320.

In some embodiments, the blade module 200 may be defined by connecting the first rounded edge 205 to the second rounded edge 210, connecting the second rounded edge to a second straight edge 245, connecting the second straight edge 245 to a first straight edge, and connecting the first straight edge to the first rounded edge 205, illustrated at least in FIGS. 1A, 2A, 3A, 4A, and 5A.

In other embodiments, the blade module 200 may be defined by the following:
a. the first rounded edge 205 connected to following:
   i. a first end of the second rounded edge 210 via a first end of the first rounded edge 205, and
   ii. a first end of the first straight edge 240 via a second end of the first rounded edge 205;
b. the second rounded edge 210 connected to the following:
   i. the first end of the first rounded edge 205 via the first end of the second rounded edge 210, and
   ii. a first end of a second straight edge 245 via a second end of the second rounded edge 210; and
c. a second end of the second straight edge 245 connected to a second end of the first straight edge 240.

In still further embodiments, blade module 200 may comprise the first straight edge 240, illustrated at least in FIG. 1A. In yet still further embodiments, blade module 200 may comprise the second straight edge 245, illustrated at least in FIG. 1A. In some embodiments, the first straight edge 240 and the second straight edge 245 may connect on one end. In some embodiments, the first straight edge 240 and the second straight edge 245 connecting on one end may form a corner 250, illustrated at least in FIGS. 1A, 2A, 3A, 4A, and 5A. In some embodiments, the corner may arc perpendicularly to the plane of blade module 200. In some embodiments, the perpendicularly and/or orthogonally arced corner may comprise a corner aperture 255, illustrated at least in FIGS. 1A, 2A, 3A, 4A, and 5A. The corner aperture may be used to thread and/or secure a connecting wire through the corner. In even yet still further embodiments, blade module 200 may form a heart-like shape, illustrated at least in FIGS. 1A, 2A, 3A, 4A, and 5A.

In some embodiments, the first rounded edge 205 may curve in a perpendicular and/or orthogonal direction to the plane of blade module 200. In some embodiments, a second rounded edge 210 may curve in a perpendicular and/or orthogonal direction to the plane of blade module 200 and/or curve orthogonally from the planar surface of the blade module 200. In some embodiments, the first rounded edge 205 may curve in an opposite direction as the second rounded edge 210. The plurality of curved rounded edges may be used to provide lift while apparatus 100 is reeled in. The plurality of curved rounded edges may be further used to maintain direction while apparatus 100 is reeled in. The plurality of curved rounded edges may be yet further used disturb the surface of the water while apparatus 100 is reeled in.

In still further embodiments, blade module 200 may comprise at least one aperture 260, illustrated at least in FIGS. 1A, 2A, 3A, 4A, and 5A.

In still further embodiments, blade module 200 may be configured to secure to a top segment 310 of a blade-bell wire 305 via a wire securing means disposed on the blade module 200 and/or the aperture.
b. Blade-Bell Wire Module 300

FIGS. 1A-5D illustrate a blade-bell wire module 300 consistent with an embodiment of the disclosure. The blade-bell wire module 300 may be used to connect the blade module 200 with sleeve module 400. Blade-bell wire module 300 may be used to connect the blade module 200 with a bell.

In some embodiments, blade-bell wire module 300 may comprise the blade-bell wire 305, illustrated at least in FIGS. 1A, 2A, 3A, 4A, and 5A. In some embodiments, the blade-bell wire 305 may comprise a top segment 310, illustrated at least in FIGS. 1A, 2A, 3A, 4A, and 5A. In further embodiments, the blade-bell wire may comprise a bottom segment 315, illustrated at least in FIGS. 1A, 2A, 3A, 4A, and 5A. In some embodiments, the blade-bell wire may connect to the at least one planar surface protrusion 230. In further embodiments, the blade-bell wire may connect to the corner aperture 255.

In some embodiments, blade-bell wire module 300 may comprise the wire cap 320, illustrated at least in FIGS. 1A, 2A, 3A, 4A, and 5A. In some embodiments, the wire cap 320 may connect to a distal end of the top segment 310. The wire cap 320 may be used to secure one end of the wire securing means. The wire cap 320 may be further used to prevent blade module 200 from sliding off the blade-bell wire 305 and/or to prevent linear translation of the blade module 200. By way of nonlimiting example, the wire cap 320 may be cylindrical.

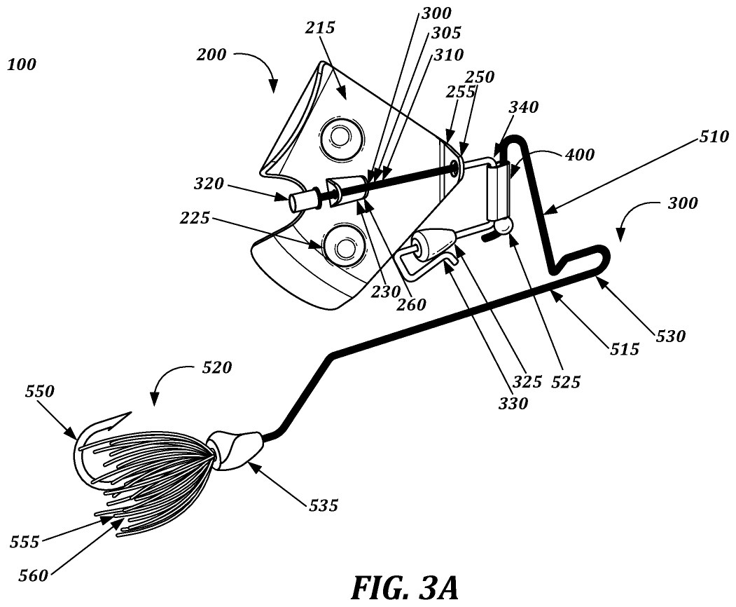

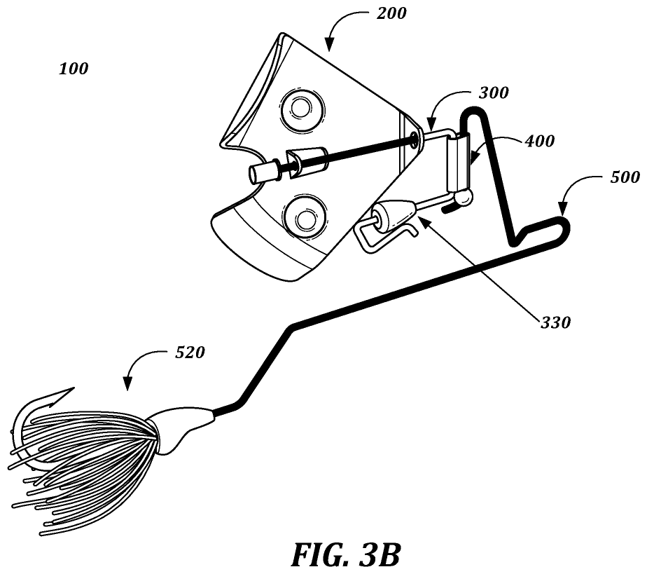

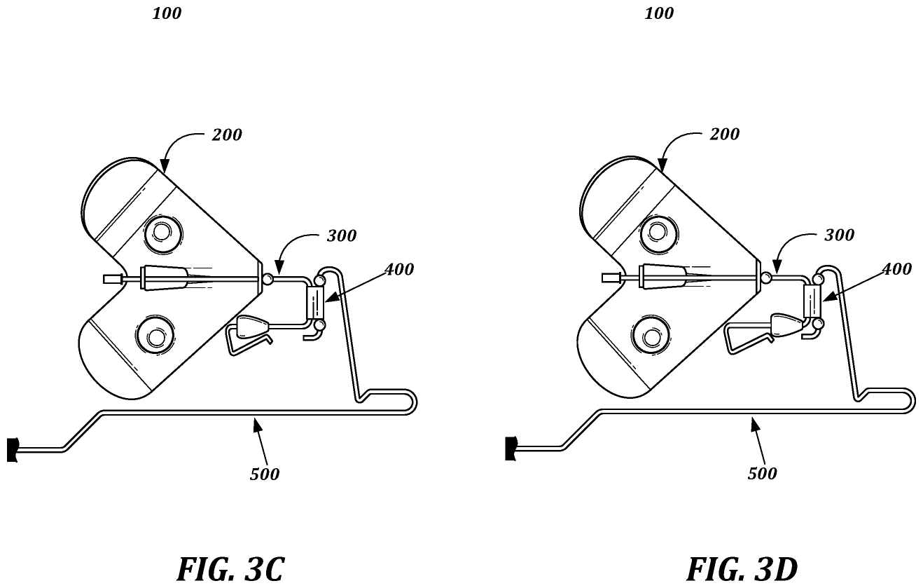

In some embodiments, blade-bell wire module 300 may comprise a first bell 325, illustrated at least in FIGS. 3A, 4A, and 5A. In some embodiments, the first bell 325 may comprise a bell aperture. In further embodiments, the first bell 325 may connect to the bottom segment 315 of the blade-bell wire 305. The first bell 325 may be disposed between a clamp 330 and a first ball 335.

The first bell 325 may be used to interact with the blade module 200, the interaction may create an audible sound and/or vibration. By way of nonlimiting example, the audible sound may be a clicking and/or buzzing sound. In some embodiments, the first bell 325 may be configured to secure on the blade-bell wire 305. In further embodiments, the first bell 325 may be configured to slide axially along the blade-bell wire 305. In yet embodiments, the first bell 325 may be configured to secure to the clamp 330. By way of nonlimiting example, when the first bell 325 is secured to the clamp 330, the first bell 325 is disengaged from interacting with the blade (in an “off” position), thereby eliminating the sound made by the first bell 325-blade module 200 interaction.

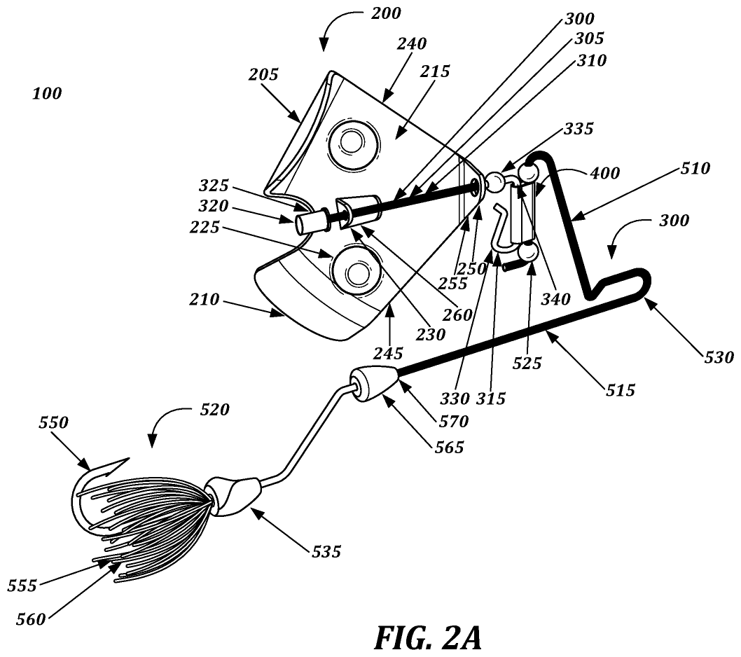

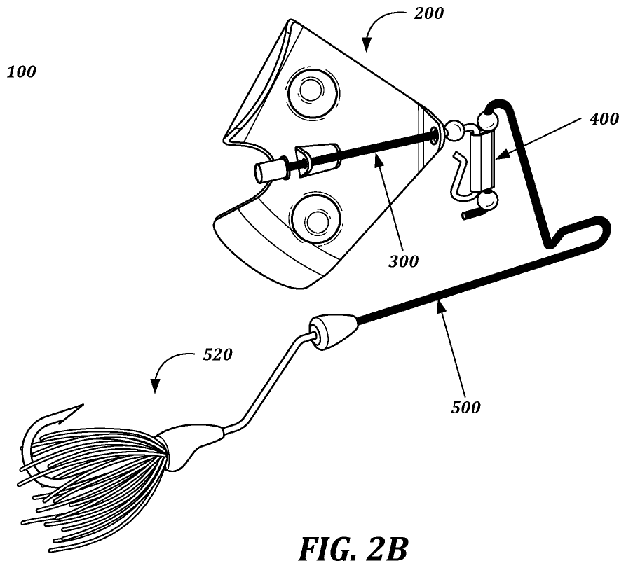

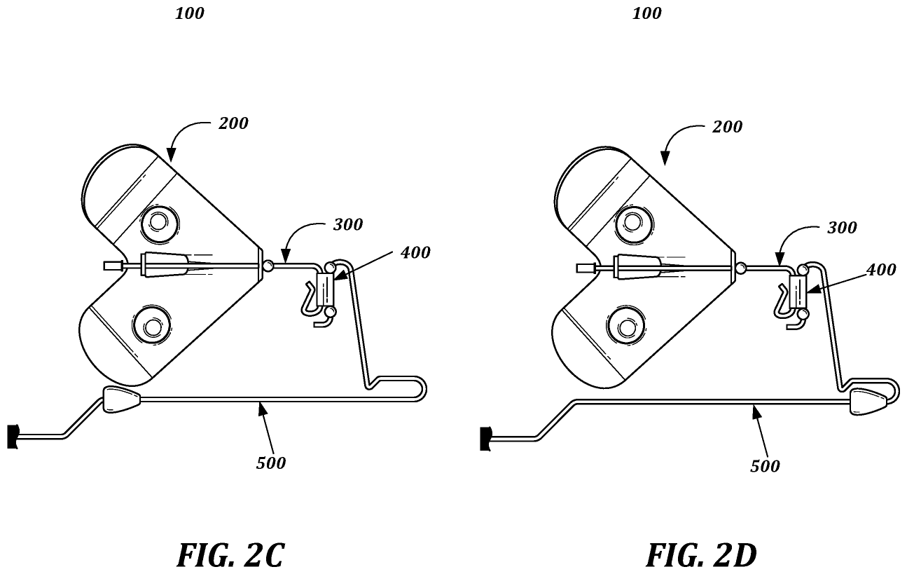

In other embodiments, the first ball 335 may be used to secure and/or prevent longitudinal translation of the blade module 200 as illustrated in FIGS. 1A-2D.

In some embodiments, blade-bell wire module 300 may comprise the clamp 330, illustrated at least in FIGS. 2A, 3A, 4A, and 5A. In some embodiments, the clamp 330 may be disposed at the distal end of the bottom segment 315 of the blade-bell wire 305. The clamp 330 may be used to prevent the first bell 325 and/or the first ball 335 from disconnecting from the bell-blade wire 305. The clamp 330 may be used to secure the first bell 325 and/or first ball 335.

In some embodiments, blade-bell wire module 300 may comprise the first ball 335, illustrated at least in FIGS. 1A, 2A, 3A, 4A, and 5A. In some embodiments, the first ball 335 may comprise a ball aperture. In some embodiments, the first ball 335 may be configured to connect to the blade-bell wire 305 and/or bottom segment 315 via the ball aperture. In other embodiments, the first ball 335 may be configured to slide traverse longitudinally along the blade-bell wire 305 and/or bottom segment 315. In yet further embodiments, the first ball 335 may be configured to reside between the clamp and the first bell 325. The first ball 335 may be used to interact with the first bell 325. The first ball 335 may be used to sequester and/or prevent longitudinal motion of the first bell 325. The first ball 335 may be used to keep the first bell 325 in alignment with the blade-bell wire 305 and blade module 200.

The blade module 200 connected to the blade-bell wire module 300 may be configured to axially rotate about a sleeve module 400. By way of nonlimiting example, when a fish attempts to bite the top water fishing lure apparatus, the force of the water from the mouth of the fish rotates the blade away from the hook increasing the chance of the fish getting caught by the hook.

In other embodiments, blade-bell wire module 300 may comprise a securing segment 340, illustrated at least in FIGS. 2A, 3A, 4A, and 5A. The securing segment 340 may be disposed between the top segment 310 and the bottom segment 315. The securing segment 340 may be configured to secure the blade-bell wire module 300 to a sleeve module 400. In some embodiments, the securing segment 340 may be oriented longitudinally at a substantially ninety-degree angle from the tope segment 310 and/or the bottom segment 315. In other embodiments, the securing segment 315 may comprise a second ball 345 (not shown) configured to further secure the blade-bell wire 305 to the sleeve 400.

In some embodiments, the top segment 310 may be substantially parallel to the bottom segment 315.
c. Sleeve Module 400

FIGS. 2A-5D illustrate sleeve module (used interchangeably with “sleeve”) 400 consistent with an embodiment of the disclosure. The sleeve 400 may be used to connect the blade-bell wire 305 to a bait wire 505 and/or a bait module 500. The sleeve 400 may be used to house the bell-blade wire 305 to the bait wire 505 and/or the bait module 500.

In some embodiments, at least a portion of the bell-blade wire 305 may be housed in the sleeve 400. In some embodiments, the sleeve 400 may comprise one or more top apertures. In some embodiments, at least a portion of the top segment 310 may connect to one of the one or more top apertures. In some embodiments, at least a portion of the top segment 310 may be disposed above the one or more top apertures. By way of nonlimiting example, the top segment 310 of the blade-bell wire 305 may bend ninety degrees after exiting the top aperture.

In some embodiments, the sleeve may comprise a bottom aperture. In some embodiments, at least a portion of the bottom segment 315 may connect to the bottom aperture. In some embodiments, at least a portion of the bottom segment 315 may be disposed below the bottom aperture. By way of nonlimiting example, the bottom segment 315 of the blade-bell wire 305 may bend ninety degrees after exiting the bottom aperture.

In other embodiments, the sleeve 400 may be embodied as, for example, a tension means, coil, and/or a spring. In other embodiments, the sleeve 400 may be embodied as, for example, a looped wire.

In some embodiments, the sleeve 400 may allow rotational freedom of the blade-bell wire 305 orthogonal to the orientation of the sleeve 400. In some embodiments, the sleeve 400 securing to the top bait wire segment 510 allows rotational freedom of the bait module 500 orthogonal to the orientation of the sleeve 400.
d. Bait Module 500

FIGS. 1A-5D and 7A-8C illustrate the bait module 500 consistent with an embodiment of the disclosure. In some embodiments, the bait module 500 may comprise the bait wire 505, illustrated at least in FIGS. 1A, 2A, 3A, 4A, and 5A. The bait wire 505 may be oriented such that a hook assembly 520 does not contact the blade module 200.

In some embodiments, the bait wire 505 may comprise a top bait wire segment 510, illustrated at least in FIGS. 1A, 2A, 3A, 4A, and 5A. The top bait wire segment 510 may be used to secure the bait module 500 to the sleeve module 400. In some embodiments, the top bait wire segment 510 may be configured to secure to the sleeve module 400 on a distal end of the top bait wire segment 510. In further embodiments, at least a portion of the top bait wire segment 510 may be disposed below the sleeve module 400. The top bait wire segment 510 may comprise a third ball 525 configured to further secure the bait module 500 to the sleeve.

In some embodiments, the bait wire 505 may comprise a bait module clamp 530, illustrated at least in FIGS. 1A, 2A, 3A, 4A, and 5A. The bait module clamp 530 may be disposed between the top bait wire segment 510 and a bottom bait wire segment 515. In other embodiments, the bait module clamp 530 may be a distal end of the top bait wire segment 510 and/or a distal end of the bottom bait wire segment 515.

In yet further embodiments, the bait module 500 may comprise the bottom bait wire segment 515, illustrated at least in FIGS. 1A, 2A, 3A, 4A, and 5A. In some embodiments, the bottom bait wire segment 515 may be configured to connect to the hook assembly 520, illustrated at least in FIGS. 1A, 1B, 2A, 2B, 3A, 3B, 4A, 4B, 5A, and 5B. In further embodiments, the bottom bait wire segment 515 may be configured to reside and/or be oriented such that the bottom bait wire segment 515 is disposed below the sleeve module 400. The bottom bait wire segment 515 may be used to secure the bait module 500 to the hook assembly 520.

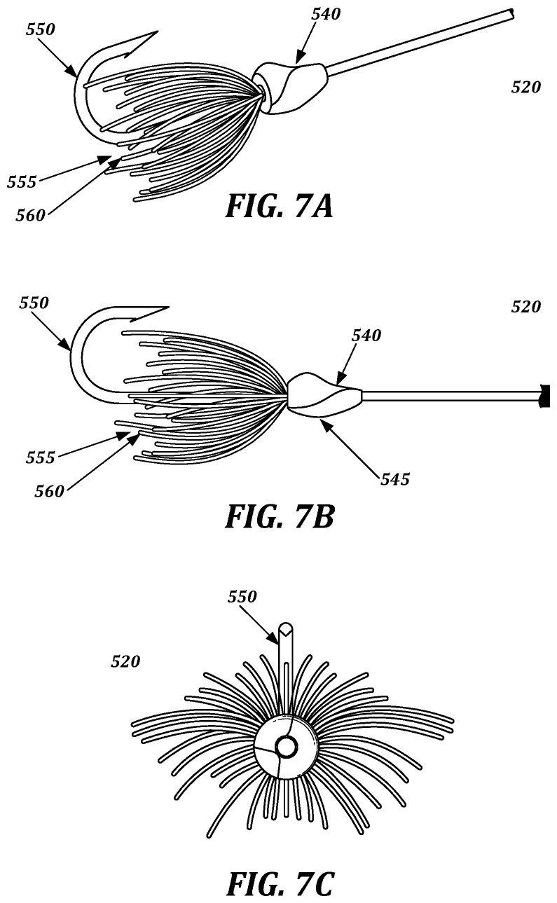

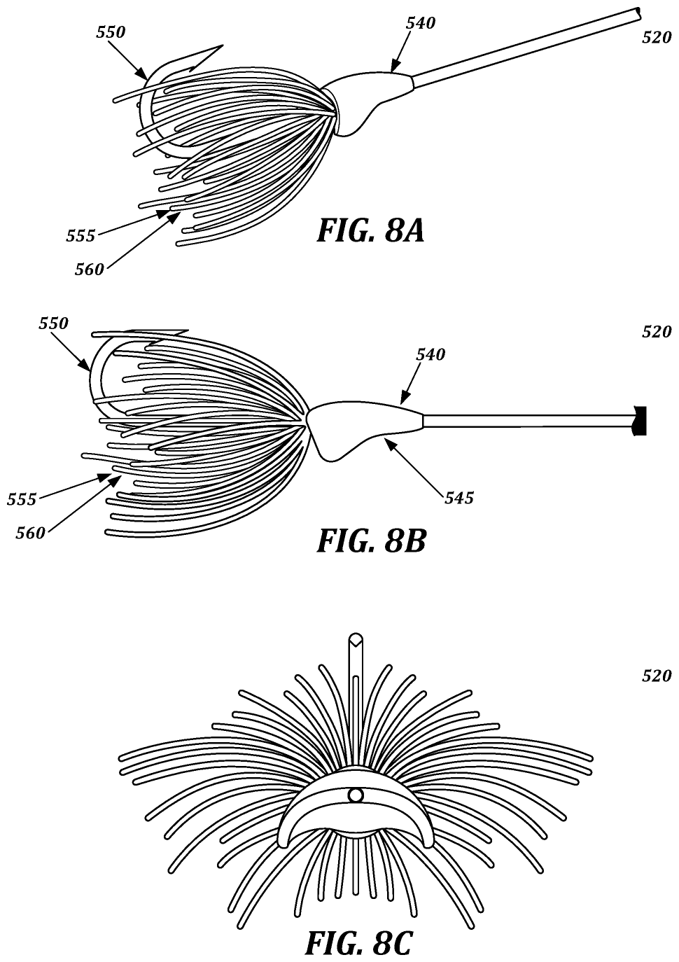

In still further embodiments, hook assembly 520 may comprise a head housing (and/or “head”) 535, illustrated at least in FIGS. 1A, 1B, 2A, 2B, 3A, 3B, 4A, 4B, 5A, 5B, and 7A-8C. The head housing 535 may be used to house a skirt and/or a hook. The head housing 535 may be secured to a distal end of the bottom bait wire segment 515. The head housing 535 may be used to keep apparatus 100 vertical when being reeled in. The head housing 535 may be used to prevent apparatus 100 from rotating from a vertical position to a horizontal position when being reeled and/or pulled. By way of nonlimiting example, the head housing 535 may have an asymmetric pyramidal shape, illustrated at least in FIGS. 7A-7C. In some embodiments, the head housing 535 may comprise a plurality of top portions 540, illustrated at least in FIGS. 7A-8C. In some embodiments, the plurality of top portions 540 may connect and form an edge. In some embodiments, the head housing 535 may comprise a bottom portion 545, illustrated at least in FIGS. 7A-8C. In some embodiments, the bottom portion 545 may be curved as a semicircle, illustrated at least in FIG. 8C. In further embodiments, the bottom portion 545 may be curved as a first semicircle on the bottom and second semicircle on the top, opposite one another, illustrated at least in FIG. 8C. This embodiment may be used to create a turning force opposite the force of the blade module 200.

In yet further embodiments, hook assembly 520 may comprise a hook 550. In some embodiments, the hook 550 may comprise a curved segment. In some embodiments, the curved segment may comprise a barb. The barb may be used to ensure a fish stays on the hook 550 when caught. It is noted that the hook 550 may be embodied as one hook, at least one hook, and/or a plurality of hooks. In some embodiments, the hook 550 may connect to the head housing 535 via a distal end of the hook 550. In further embodiments, the hook 550 may reside and/or be disposed at the distal end of the bait wire 505. In some embodiments, at least a portion of the hook 550 may be configured to connect to the head housing 535.

In still further embodiments, bait module 500 may comprise a skirt 555, illustrated at least in FIGS. 1A, 1B, 2A, 2B, 3A, 3B, 4A, 4B, 5A, 5B, and 7A-8C. The skirt 555 may be used to visibly conceal the hook 550, illustrated at least in FIGS. 1A, 1B, 2A, 2B, 3A, 3B, 4A, 4B, 5A, 5B, and 7A-8C. The skirt 555 may be used to appear like an insect. In some embodiments, at least a portion of the skirt 555 may be configured to connect to the head housing 535. By way of nonlimiting example, a soft plastic bait may be used without a skirt 555, and/or used with a piece of food and/or an edible item.

In even further embodiments, bait module 500 may comprise a trailer keeper 560, illustrated at least in FIGS. 1A, 1B, 2A, 2B, 3A, 3B, 4A, 4B, 5A, 5B, and 7A-8C. In some embodiments, the trailer keeper 560 may connect to the hook 550. In further embodiments, the trailer keeper 560 may reside between the head housing 535 and the distal end of the hook 550. In further embodiments, the trailer keeper 560 may reside between the head housing 535 and the skirt 555. In yet further embodiments, the trailer keeper 535 may be configured to create lift while the apparatus 100 is pulled through water and/or any suitable fluid.

In some embodiments, the bottom bait wire segment 515 may comprise a bait module bell 565, illustrated at least in FIGS. 1A and 2A. In some embodiments, the bait module bell 565 may comprise a bait module bell aperture 570, illustrated at least in FIGS. 1A and 2A. The bait module bell aperture 570 may be used to allow translational movement of the bait module bell 565 along the length of the bottom bait wire segment 515. The bait module bell 565 may be configured to be in an “off” position and an “on” position. In some embodiments, in the “off” position, the bait module bell 565 is secured to the bait module clamp 530, illustrated at least in FIGS. 1D and 2D. In some embodiments, in the “on” position, the bait module bell 565 is disposed between the bait module clamp 530 and the hook assembly 520, illustrated at least in FIGS. 1A-1C and 2A-2C. In further embodiments, in the “on” position, the blade module 200 is configured to contact the bell during a rotation of the blade module 200.

In other embodiments, the bait wire 505 and the blade-bell wire module 300 and/or blade-bell wire 305 may be the same, as illustrated in FIGS. 1A-1D.
e. Double Blade Module 600

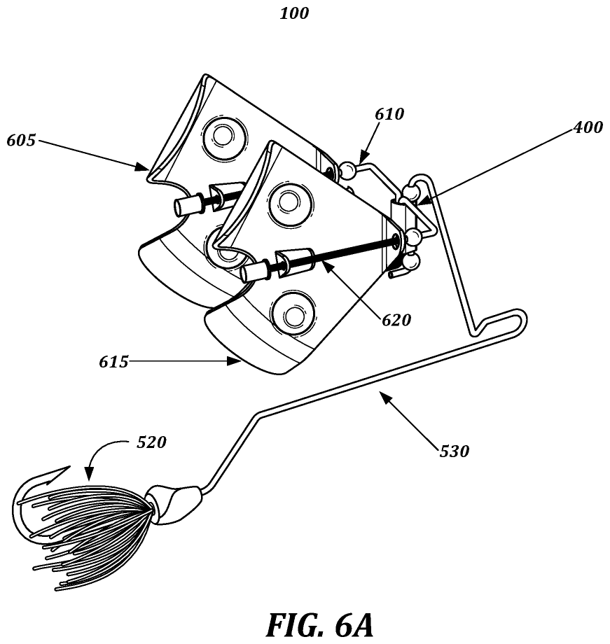

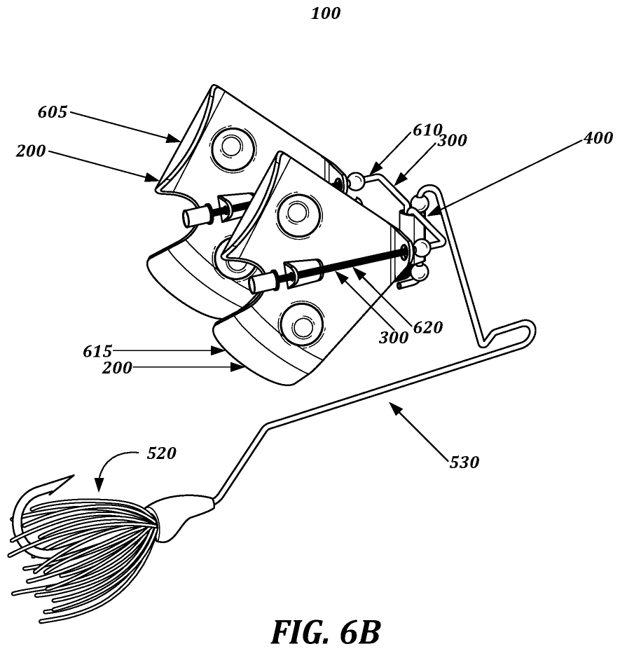

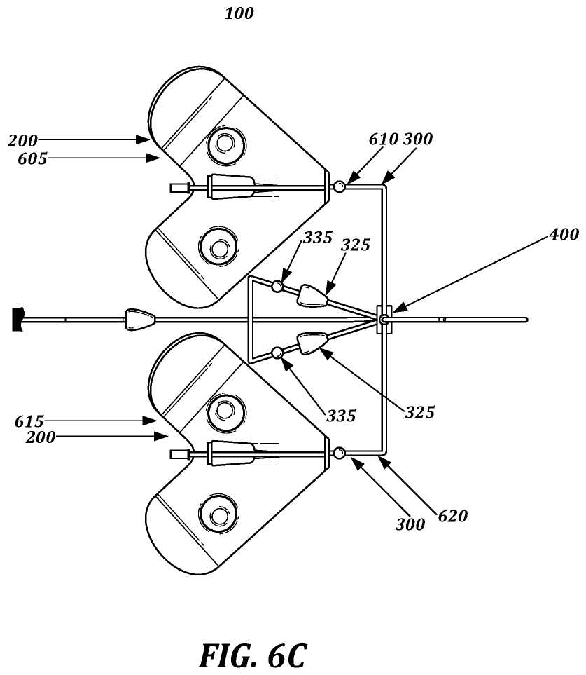

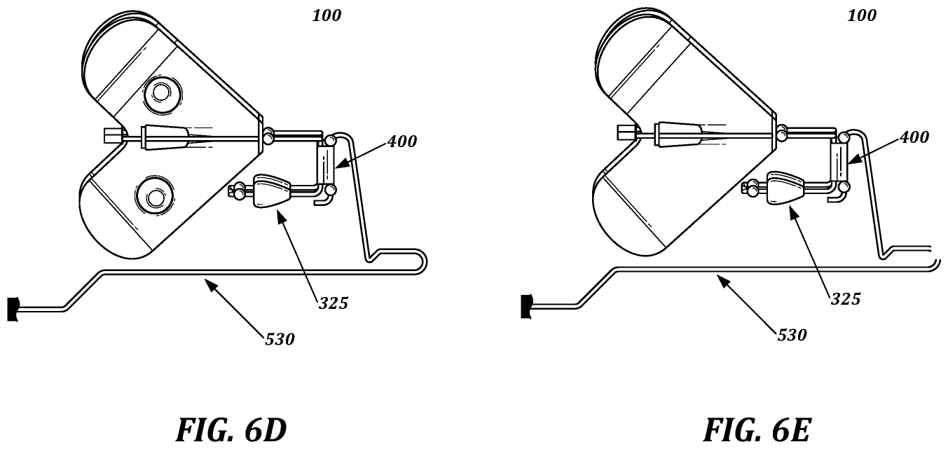

FIGS. 6A-6E illustrate a double blade module 600 consistent with an embodiment of the disclosure. In some embodiments, double blade module 600 may comprise a first blade module 605, illustrated at least in FIGS. 6A and 6C. In some embodiments, the first blade module may connect to a first blade-bell wire module 610, illustrated at least in FIGS. 6A and 6C. In further embodiments, the first blade-bell wire module 610 may connect to the sleeve module 400.

In some embodiments, double blade module 600 may comprise a second blade module 615, illustrated at least in FIGS. 6A and 6C. In some embodiments, the second blade module 615 may connect to a second blade-bell wire module 620, illustrated at least in FIGS. 6A and 6C. In further embodiments, the second blade-bell wire module may connect to the sleeve module 400.

In further embodiments the first blade module 605 may be positioned such that interaction, contact, and/or interference does not occur with the second blade module 620.

In some embodiments, each of the first blade module 605 and second blade module 615 may comprise some or all portions and/or functionality of the blade module 200 including, but not limited to, the interactions, connectivity, and/or communication with any other module.

### III. Apparatus/System Use

Embodiments of the present disclosure provide a set of methods comprising configured to operate the aforementioned components in accordance with the methods. The following depicts an example of a method of a plurality of methods that may be performed by at least one of the aforementioned components. Various components may be used at the various stages of operations disclosed with reference to each component.

For example, although methods may be described to be performed by a single component, it should be understood that, in some embodiments, different operations may be performed by different components in operative relation with one another. For example, an apparatus may be employed in the performance of some or all of the stages disclosed with regard to the methods.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed from the without altering or deterring from the fundamental scope of the depicted methods and systems disclosed herein.

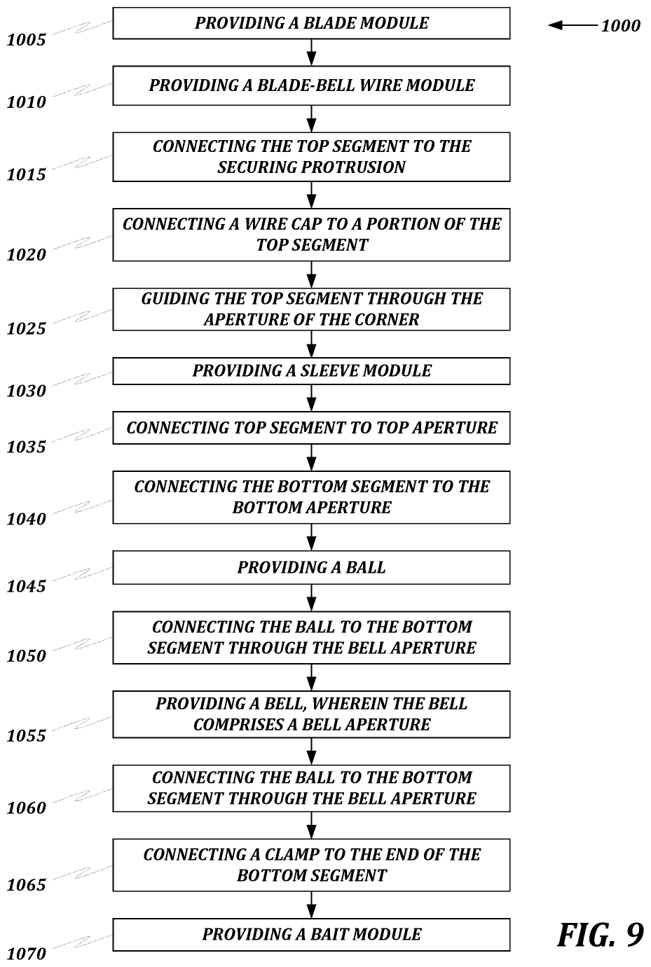

Consistent with embodiments of the present disclosure, a method may be performed by at least one of the aforementioned components. The method may comprise the following stages, illustrated in FIG. 9:
a. 1000—Method for Providing a Top Water Fishing Lure Apparatus

1005—Providing a blade module 200 comprising:
i. providing a first rounded edge 205,
ii. providing a second rounded edge 210,
iii. providing a first straight edge 240,
iv. providing a second straight edge 245,
v. connecting one end of the first straight edge 240 to one end of the second straight edge 245, creating a corner 250,
   1. wherein the corner 250 comprises an aperture 255,
vi. forming a planar surface by connecting the first rounded edge 205, the second rounded edge 210, the first straight edge 240, and the second straight edge 245,
vii. curving the corner 250 perpendicularly to the planar surface 215,
viii. providing at least one planar surface protrusion 225,
ix. providing a securing protrusion 230, and
x. providing a rivet sleeve 235, wherein the rivet sleeve does not stick out beyond blade and the wire does not extend beyond rivet sleeve.

1010—providing a blade-bell wire module 300 comprising:
i. providing a blade bell wire 305, wherein the blade bell wire 305 comprises:
   1. providing a top segment 310, and
   2. providing a bottom segment 315,

1015—connecting the top segment 310 to the securing protrusion 230,

1020—connecting a wire cap 320 to a portion of the top segment 310 protruding from the securing protrusion 230,

1025—guiding the top segment 310 to through the aperture 255 of the corner 250,

1030—providing a sleeve module 400, comprising providing a sleeve 400, wherein the sleeve 400 comprises:
i. providing a top aperture, and
ii. providing a bottom aperture,
iii. variation 1: the sleeve module 400 being used to allow axial rotation of the blade module 200;

1035—connecting the top segment 310 to the top aperture;

1040—connecting the bottom segment 315 to the bottom aperture;

1045—providing a ball, wherein the ball comprises a ball aperture;

1050—connecting the ball to the bottom segment 315 through the bell aperture;

1055—providing a bell, wherein the bell comprises a bell aperture;

1060—connecting the ball to the bottom segment 315 through the bell aperture;

1065—connecting a clamp to the end of the bottom segment 315;

1070—providing a bait module 500 comprising:
i. providing a bait wire 505,
ii. providing an top bait wire segment 510,
iii. connecting the top bait wire segment 510 to the sleeve 400,
iv. providing a bottom bait wire segment 515,
v. connecting the bottom bait wire segment 515 to the sleeve 400;
vi. providing a head housing 535,
vii. connecting the head housing 535 to the distal end below the bottom bait wire segment 515,
viii. connecting a hook 550 to the head housing 535,
ix. connecting a trailer keeper 560 to the head housing 535, and
x. connecting a skirt to the head housing 535.

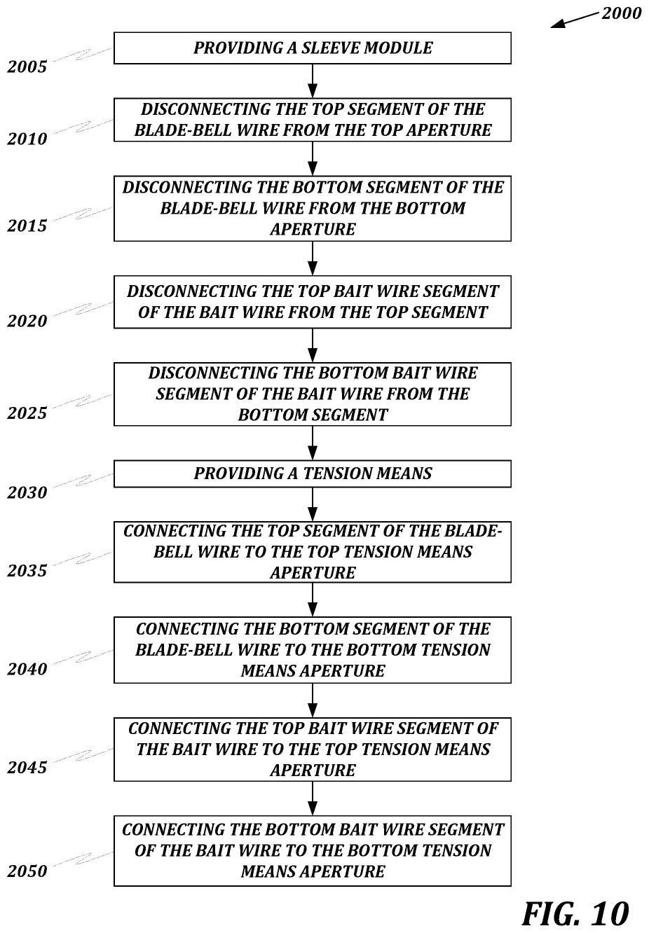

The following method may comprise the following stages, illustrated in FIG. 10:
a. 2000—Method for Replacing a Sleeve with a Spring

2005—Providing a sleeve module, comprising providing a sleeve 400, wherein the sleeve 400 comprises:
i. providing a top aperture, and
ii. providing a bottom aperture,
iii. wherein a top segment 310 of a blade-bell wire 305 is connected to the top aperture,
iv. wherein a bottom segment 315 of the blade-bell wire 305 is connected to the bottom aperture,
v. wherein an top bait wire segment 510 of a bait wire 505 is connected to the top aperture,
vi. wherein a bottom bait wire segment 515 of the bait wire 505 is connected to the bottom aperture;

2010—disconnecting the top segment 310 of the blade-bell wire 300 from the top aperture;

2015—disconnecting the bottom segment 315 of the blade-bell wire 300 from the bottom; aperture;

2020—disconnecting the top bait wire segment 510 of the bait wire 505 from the top segment;

2025—disconnecting the bottom bait wire segment 515 of the bait wire 505 from the bottom segment;

2030—providing a tension means comprising:
i. providing a top tension means aperture, and
ii. providing a bottom tension means aperture,

2035—connecting the top segment 310 of the blade-bell wire 300 to the top tension means aperture;

2040—connecting the bottom segment 315 of the blade-bell wire 300 to the bottom tension means aperture;

2045—connecting the top bait wire segment 510 of the bait wire 300 to the top tension means aperture; and

2050—connecting the bottom bait wire segment 515 of the bait wire 300 to the bottom tension means aperture.

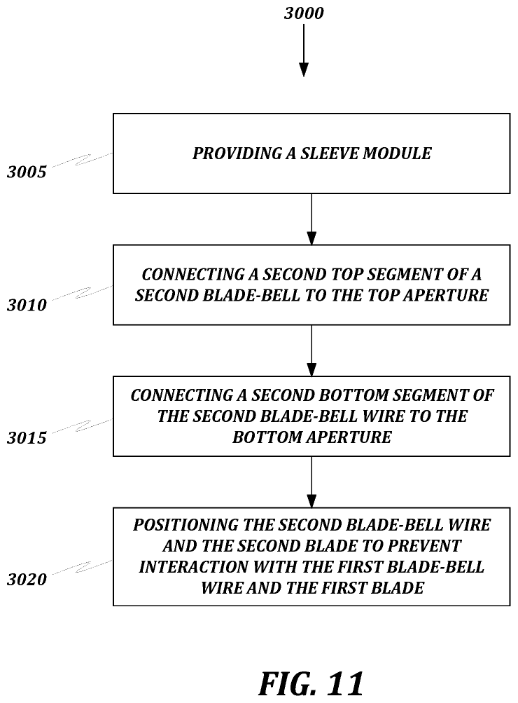

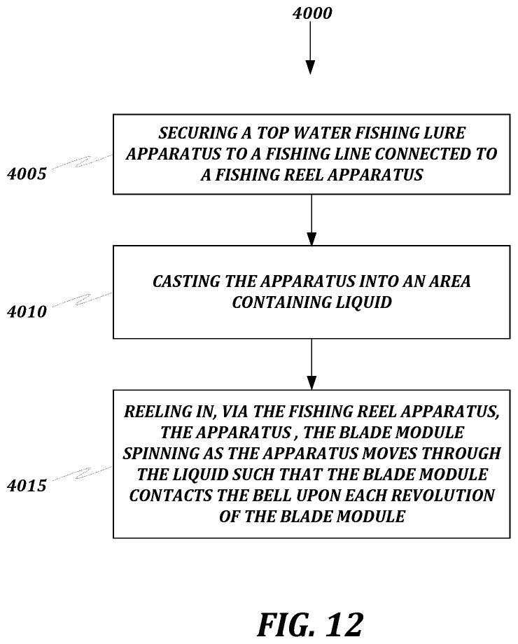

The following method may comprise the following stages, illustrated in FIG. 11:
c. 3000—Method for Changing a Single Blade Module to a Double Blade Module on a Top Water Fishing Lure Apparatus

Providing a top water fishing lure apparatus 100 comprising:
a. 3005—Providing a sleeve module 400, comprising providing a sleeve 400, wherein the sleeve 400 comprises:
   i. providing a top aperture, and
   ii. providing a bottom aperture,
   iii. wherein a first top segment 310 of a first blade-bell wire is connected to the top aperture,
      1. wherein the first top segment of a first blade-bell wire is connected to a first blade,
   iv. wherein a first bottom segment of the first blade-bell wire is connected to the bottom aperture,
      1. wherein the first bottom segment of a first blade-bell wire is connected to a first ball, a first clamp, and a first bell,
   v. wherein a top bait wire segment of a bait wire is connected to the top aperture,
   vi. wherein a bottom bait wire segment of the bait wire is connected to the bottom aperture;
b. 3010—connecting a second top segment 310 of a second blade-bell to the top aperture,
   i. wherein the second segment of a second blade-bell wire is connected to a second blade;
c. 3015—connecting a second bottom segment of the second blade-bell wire to the bottom aperture,
   i. wherein the second bottom segment of a second blade-bell wire is connected to a second ball, a second clamp, and a second bell,
d. 3020—Positioning the second blade-bell wire and the second blade to prevent interaction with the first blade-bell wire and the first blade.

The following method may comprise the following stages, illustrated in FIG. 11:
d. 4000—Method for Casting and Reeling a Top Water Fishing Lure Apparatus
4005—Securing a top water fishing lure apparatus 100 to a fishing line connected to a fishing reel apparatus;
a. Wherein the apparatus 100 is in an “on” position, the “on” position having a bell 565 connected around a bottom bait wire segment 515 such that a blade module 200 is in spatial proximity to the bell 565.
   i. (Alternate) Wherein the apparatus 100 is in an “on” position, the “on” position having a bell 325 connected around a bottom segment 315 such that a blade module 200 is secured to a clamp 330 and in spatial proximity to the bell 325,
   ii. (Alternate) Wherein the apparatus 100 is in an “off” position, the “off” position having a bell 325 connected around a bottom segment 315 such that a blade module 200 is not in spatial proximity to the bell 325,
   iii. (Alternate) Wherein the apparatus 100 is in an “off” position, the “off” position having a bell 565 connected around a bottom bait wire segment 515 and secured to a clamp 530 such that a blade module 200 is not in spatial proximity to the bell 565.

4010—Casting the apparatus 100 into an area containing and/or channeling liquid.

4015—Reeling in, via the fishing reel apparatus, the apparatus 100, the blade module 200 spinning as the apparatus moves through the liquid such that the blade module 200 contacts the bell upon each revolution of the blade module 200.

(Alternate) Reeling in, via the fishing reel apparatus, the apparatus 100, the blade module 200 spinning as the apparatus moves through the liquid such that the blade module 200 does not contact the bell upon each revolution of the blade module 200.

Although the stages are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed from the without altering or deterring from the fundamental scope of the depicted methods and systems disclosed herein.

### VI. Aspects

The following disclose various Aspects of the present disclosure. The various Aspects are not to be construed as patent claims unless the language of the Aspect appears as a patent claim. The Aspects describe various non-limiting embodiments of the present disclosure.

Aspect 1. Fishing lure may include one or more blades, with each blade being rotatably attached to a wire that extends along the long axis of the blade (e.g., a ‘Buzzbait’-type lure). The spinning blade assembly may also rotate/pivot about an axis orthogonal to the long axis, allowing the blade to swing.
Solution it brings:

a. A better hook-up ratio (e.g., increased likelihood that a fish striking the lure will become hooked by the hook disposed within the lure) may occur due to blade swinging,

b. There is better lift in the water, without side tilt due to head shape. By way of nonlimiting example, the head housing may have an asymmetric pyramidal shape. In some embodiments, the head housing may comprise a plurality of top portions. In some embodiments, the plurality of top portions may connect and form an edge. In some embodiments, the head housing may comprise a bottom portion. In some embodiments, the bottom portion may be curved as a semicircle. In further embodiments, the bottom portion may be curved as a first semicircle on the bottom and second semicircle on the top, opposite one another.

### Aspect 2. Physical Description of The Lure:

### How the Lure Functions:

85% of the time Bass strike lures from the side pushing the lure away from its mouth, so a lure was created with a swing blade that moves to the side as a fish strikes, making it easier for the fish to catch the bait and increase the hook-up ratio.

Aspect 3. The single lure is comprised of:

A Blade assembly connected to a hook assembly through a coupling sleeve/collar (3) that enables the hook and blade assemblies to pivot relative to one another about the longitudinal axis of the sleeve (3).

### Aspect 4. (3)—Sleeve

The sleeve may connect blade and hook assemblies via coupling (3)—connecting wire (3a) and (5)—hook assembly wire.

The wire may be secured with sleeve is inside of the blade to prevent the line from catching the wire and debris in the water.

Sleeves connects second wire with two beads holding it in place, attached to head of lure.

### Aspect 5.

Blade assembly.

Generally heart-shaped blade having a generally planar rectangular section, a first curved section, and a second curved section, wherein the first curved section is connected to a first side of the generally planar rectangular section and the second curved section is connected to a second side of the generally planar rectangular section, the second side being adjacent to the first side.

A blade tip located opposite from the first side and the second side, the blade tip folded up such that the blade tip is substantially orthogonal to the plane defined by the substantially planar rectangular section, and wherein the blade tip defines a hole to accommodate a connecting wire (e.g., the blade-bell wire).

The first curved section may extend in a first direction normal to the plane defined by the generally rectangular section, and the second curved section may extend in a second direction opposing the first direction.

One or more indented circular protrusions may be disposed on the generally planar rectangular portion of the blade.

The indented circular protrusions may be configured to create a popping noise and increase a lift force generated by the lure. The circular protrusions may be further configured to trap the air, creating bubbles.

The blade may connect to a wire (e.g., the blade-bell wire member) at least at an attachment point.

The wire may run along a central longitudinal axis of the blade.

The blade may comprise a tab disposed at a point approximately ³A (three-quarters) of the way from the tip-(e.g., the blade tip) to-tail along the central longitudinal axis. The tab being folded out of the plane of the blade, and creating a hole in in the blade.

The tab may be folded to the same side as the blade tip feature described above.

The tab and/or the blade tip may define a hole or aperture sized sufficiently to allow translation and/or rotation of the blade around the connecting wire without substantial, undesirable ‘wobble’, of the way through center of blade, remnants from a hole is opened up with a smaller hole for the connecting wire to pass through. The wire extends above and to the end of the blade, secured by a single cylinder sleeve/rivet.

Cap/cylinder sleeve—prevents blade from sliding off a connecting wire,

Connecting wire with features:

Connecting wire bends approximately ninety degrees traveling through the bore of sleeve, then bending another approximately 90 degrees in-plane with the first bend thus returning it to parallel with the initial wire section where it is met with a clicker, created by a ball and bell and recurve/clamp feature,

ON/Off Clicker Assembly,

Ball,

Bell,

Recurved clamp feature of connecting wire to engage/disengage the ball and bell clicker system,

Bell can slide axially along connecting wire transiting feature recurve feature,

When the bell is displaced axially to the sleeve side of the recurve feature the clicker is disengaged (Off),

When the bell is displaced axially to the blade side of the recurve feature the clicker is engaged (On),

The wire on the bottom of the blade is shaped similar to a clamp to allow clicker to be pulled forward to turn off and pushed backwards to turn on the clicking sounds as the blade rotates in the water on fishing line, attracting fish with its sound.

The spinning blade hits the clicker, the bell and ball below the blade, making a clicking noise. The clicker is designed with a small bell over a ball that moves with blade. The bell and ball give more tolerance in movement to click without stopping the blade.

The fish is attracted to the sound, splash, bubbles and reflection from the blade.

### Aspect 6.

Hook Assembly.

Hook Assembly Wire.

Recurved portion for connecting lure to fishing line.

Head.

The head of the lure is located distally to the tail end of the main blade relative to the sleeve.

The head of lure is generally an asymmetric pyramidal shape.

Elongated at the tip, underside of the back of head is widened at the base.

The double blade has a symmetrical head with an arch on the bottom.

One side of the head is lifted approximately forty-five degrees, the other side curved in a semicircle.

### Aspect 7.

The head holds skirt, and hook for the lure,

The head design prevents the lure from running on the side. Traditionally, blades push the top lure wire, so lure has a tendency to run on the side or horizontally. This head shape creates an opposing force to the blade making the lure run vertically. It also creates a lift on the lure so that the retrieval/reeling in of the lure at a slower speed. This lift creates more bubbles to attract fish.

When the bait is reeled on the line in the water, the spinning blade and the shape of the head lifts the lure on the surface of the water.

### Aspect 8. Double Lure:

The double lure is comprised of:

Sleeve,

Same as single; a larger diameter bore to accommodate passage of 3 wires instead of 2 as in single blade embodiment described previously in Single Blade Assembly (SBA).

Double Blade assembly,

Blade—two blades, each with the features as described previously in SBA,

Cap/cylinder sleeve,

Two sleeves.

At terminal end of connecting wire at tail end of blade.

prevents blade from sliding off wire.

Connecting wire with features,

Connecting wire extends through the long axis of the blade as described in SBA.

A bead is mounted on the connecting wire adjacent to the bent tip of the blade to prevent unwanted axial translation of the blade along the connecting wire and more weed less.

Distal to the bead the wire is bent approximately 90 degrees, defining an in-plane ‘ell’ shape.

Subsequently the wire is bent another approximately 90 degrees, orthogonal to the plane defined by the 1^{st} two bends and travels downward through the bore of the collar/sleeve.

Upon passing through the collar, the wire is again bent approximately 90 degrees bringing it substantially parallel to the plane defined by the afore mentioned ‘ell’ shape.

While remaining substantially parallel to the above described plane, the wire is bent at an acute angle (e.g., in the range of 30-45 degrees) away from the central longitudinal axis of the lure.

This wire section contains the first of two ball and bell clicker assemblies in which the bell axially translates along the connecting wire to engage/disengage clicker mechanism.

Finally the wire is again bent until it is substantially perpendicular to the long axis of the lure while maintaining co-planarity with the ‘ell’ shape.

The wire shape and features are symmetric about a plane defined by the long axis of the lure and bore of the collar/sleeve.

ON/Off Clicker Assembly,

Two clicker assemblies are included, each assembly including:

Ball,

Bell,

Bell can slide axially along wire transiting feature recurve feature,

When the bell is displaced axially to the sleeve side of the recurve feature, the clicker is disengaged (Off),

When the bell is displaced axially to the blade side of the recurve feature the clicker is engaged (On),

The wire on the bottom of the blade is shaped similar to a clamp to allow clicker to be pulled forward to turn off and pushed backwards to turn on the clicking sounds as the blade rotates in the water on fishing line, attracting fish with its sound.

The spinning blade hits the clicker, the bell and ball below the blade, making a clicking noise. The clicker is designed with a small bell over a ball that moves with blade. The bell and ball give more tolerance in movement to click without stopping the blade.

The fish is attracted to the sound, splash and reflection from the blade.

Hook Assembly,

Same as SBA unless otherwise noted,

Hook wire is bent at an acute angle away from the blade assembly in a plane defined by the axis of the sleeve and the overall long axis of the lure,

Head.

### Aspect 9. Alternate Variations:

1. Multiple blades on a single wire,

2. Two blades or more blades on separate ends of wire,

3. 0-360 degree rotation by a sleeve,

4. Head Variations,

5. Collar Variations,

a. Spring vs Sleeve vs looped wire.

Aspect 10. Solution the lure brings:

a. Better hook-up ratio, due to blade swinging,

b. Better lift in the water, without side tilt due to head shape,

c. Trail of bubbles created for fish to follow.

### Aspect 11. Physical Description of The Lure:

1. Spinning blade with indented circles,

2. Connecting wire goes through blade. Three quarters of the way through center of blade, remnants from a hole is opened up with a smaller hole for the connecting wire to pass through. The wire extends above and to the end of the blade, secured by a single cylinder sleeve/rivet,

3. Connecting wire bends ninety degrees down through a sleeve, then bent another 90 degrees towards the blade where it is met with a clicker, created by a ball and bell,

4. Wire curves down approximately ninety degrees then forward ninety degrees and travels up in an angle, curving down on its end, in the shape of a clamp,

5. Sleeves connects second wire with two beads holding it in place, attached to head of lure,

6. Head of lure is behind main blade,

7. Head of lure is elongated at the tip, underside of the back of head is widened at the base. One side of the head is lifted approximately forty-five degrees, the other side curved in a semicircle, and

8. The head holds skirt, and hook for the lure.

Aspect 12. Generally fish such as bass strike lures from the side, pushing the lure away from the mouth of the fish. Accordingly, the lure described herein includes a swing blade that moves to the side in response to a fish strike, making it easier for the fish to catch the bait and increase the hook-up ratio. The spinning blade of the lure hits the clicker (e.g., the bell and ball below the blade), making a clicking noise. The clicker may include a small bell over a ball that moves with blade. The bell and ball provide additional tolerance in movement to cause a click without stopping the blade. The wire on the bottom of the blade may be shaped similar to a clamp to allow the clicker to be pulled forward to turn off (e.g., to prevent the lure from making the clicking noise) and pushed backwards to turn on the clicking sounds as the blade rotates in the water on fishing line. In embodiments, the clicking may, attract fish with the produced sound. The indented holes on the blade may create a popping noise. Additionally, the indented holes may create more lift on the lure, and may create air bubbles. The fish may be attracted to the sound, splash, and reflection from the blade. The wire secured with the sleeve is inside of the blade to help prevent the line and/or any debris in the water from catching on the wire. When the bait is pulled on a line through the water, the spinning blade and the shape of the head may generate a lift force on the lure, causing the lure to remain on or near the surface of the water.
Aspect 13. The head design prevents the lure from running on the side. Traditionally, blades push the top lure wire, so the lure has a tendency to run on the side or horizontally. The head is shaped to create a force that opposes a force created by the blade, causing the lure to run vertically when reeled in by a user. The head may also create a lift force on the lure so that a user can retrieve (e.g., reel in) the lure at a slower speed. The shape of the blade may cause the blade to rotate during retrieval, which may create lift, and cause the blade to create more bubbles to attract fish.
Aspect 14. A blade module comprising:
a first rounded edge connected to following:

a first end of a second rounded edge via a first end of the first rounded edge, and

a first end of a first straight edge via a second end of the first rounded edge,

a second rounded edge connected to the following:

the first end of the first rounded edge via the first end of the second rounded edge, and

a first end of a second straight edge via a second end of the second rounded edge,

a second end of the second straight edge connected to a second end of the first straight edge forming the following:
a planar surface of the blade module, the planar surface comprising at least one wire securing means, and
a corner, the corner being curved orthogonally from the planar surface of the blade module.
   Aspect 15. The apparatus of any preceding aspect, wherein the bell is in spatial proximity to a portion of the blade module.

### V. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

1. A top water fishing lure apparatus comprising:
a generally heart-shaped blade comprising:
a generally rectangular portion defining a planar surface, the planar surface comprising at least one wire connecting portion,
a first rounded portion disposed on a first side of the generally rectangular portion,
a second rounded portion disposed on a second side of the generally rectangular portion, and
a corner opposite the first rounded portion and the second rounded portion, the corner being curved orthogonally from the planar surface of the blade,
wherein the first rounded portion curves orthogonally from the planar surface,
wherein the second rounded portion curves orthogonally from the planar surface and opposite from the first rounded portion,
wherein the blade is configured to secure to a top segment of a blade-bell wire via a wire securing portion;
the blade-bell wire comprising:
the top segment comprising a wire cap secured on a distal end of the top segment, the wire cap being configured to prevent linear translation of the blade,
a bottom segment comprising:
a bell secured on the bottom segment via a bell aperture,
a ball secured on the bottom segment via a ball aperture, and
a clamp on a distal end of the bottom segment, and
a securing segment disposed between the top segment and the bottom segment;
a sleeve securing to the following:
the securing segment of the blade-bell wire, and
a top bait wire segment,
wherein the top segment is oriented above the sleeve,
wherein the bottom segment is oriented below the sleeve; and
a bait module comprising a bait wire comprising:
the top bait wire segment secured to the sleeve on a distal end of the top bait wire segment,
a bottom bait wire segment comprising a hook assembly,
wherein the bait wire is oriented such that the hook assembly does not contact the blade.

2. The apparatus of claim 1, wherein the sleeve comprises a coil wrapped in a cylindrical fashion such that the sleeve exhibits spring-like properties.

3. The apparatus of claim 1, wherein the planar surface of the blade comprises at least one protrusion.

4. The apparatus of claim 1, wherein the top segment is substantially parallel to the bottom segment.

5. The apparatus of claim 1, wherein the sleeve securing to the securing segment of the blade-bell wire allows rotational freedom of the blade-bell wire orthogonal to the orientation of the sleeve.

6. The apparatus of claim 1, wherein the sleeve securing to the top bait wire segment allows rotational freedom of the hook assembly orthogonal to the orientation of the sleeve.

7. The apparatus of claim 1, wherein the hook assembly comprises:
a head housing;
a skirt;
at least one hook; and
a trailer keeper.

8. The apparatus of claim 7, wherein the head housing has a generally asymmetric pyramidal shape.

9. The apparatus of claim 7, wherein the head housing is secured to a distal end of the bottom bait wire segment.

10. The apparatus of claim 1, wherein the bell is configured to be movable between an “off” position and an “on” position.

11. The apparatus of claim 10, wherein in the “off” position, the bell is secured by the clamp.

12. The apparatus of claim 10, wherein in the “on” position, the blade is configured to contact the bell during a rotation of the blade.

13. The apparatus of claim 1, further comprising a second blade secured to a second top portion of a second blade-bell wire, the second blade-bell wire configured to secure to the sleeve, via a second securing segment;
wherein a second bottom segment of the second blade-bell wire comprises a second bell,
wherein a distal end of the second bottom segment curves towards the bottom segment of the blade-bell wire such that the second bottom segment secures to the bottom segment.

14. The apparatus of claim 1, wherein the securing segment is oriented at a generally ninety-degree angle from the top segment and the bottom segment.

15. A top water fishing lure apparatus comprising:
a generally heart-shaped blade comprising:
a generally rectangular portion defining a planar surface, the planar surface comprising at least one wire connecting portion,
a first rounded portion disposed on a first side of the generally rectangular portion,
a second rounded portion disposed on a second side of the generally rectangular portion, and
a corner opposite the first rounded portion and the second rounded portion, the corner being curved orthogonally from the planar surface of the blade,
wherein the first rounded portion curves orthogonally from the planar surface,
wherein the second rounded portion curves orthogonally from the planar surface and opposite from the first rounded portion,
wherein the blade is configured to secure to a top segment of a blade wire via a wire securing portion;
the blade wire comprising:
the top segment comprising a wire cap secured on a first distal end of the top segment, the wire cap being configured to prevent linear translation of the blade, and
a securing segment oriented at a generally ninety-degree angle from the top segment;
a sleeve securing to the following:
the securing segment of the blade wire, and
a top hook module wire,
wherein the top segment is oriented above the sleeve; and
a bait module comprising:
a bait wire comprising:
a top bait wire segment secured to the sleeve on a distal end of the top bait wire segment,
a bottom bait wire segment comprising:
a flexible curved portion disposed at a first distal end of the bottom bait wire segment and shaped such that a bell, in an “off” position, is secured within the flexible curved portion,
a hook assembly disposed at a second distal end of the bottom bait wire segment, and
the bell disposed, while in an “on” position, between the flexible curved portion and the hook assembly, the bell comprising a bell aperture allowing translational movement of the bell along the length of the bottom bait wire segment,
wherein in the “on” position, the blade is configured to contact the bell during a rotation of the blade.

16. The apparatus of claim 15, wherein the securing segment comprises at least one ball configured to further secure the blade wire to the sleeve.

17. The apparatus of claim 15, wherein the top bait wire segment comprises at least one ball configured to further secure the bait module to the sleeve.

18. A top water fishing lure apparatus comprising:
a generally heart-shaped blade comprising:
a generally rectangular portion defining a planar surface, the planar surface comprising at least one wire connecting portion,
a first rounded portion disposed on a first side of the generally rectangular portion,
a second rounded portion disposed on a second side of the generally rectangular portion, and
a corner opposite the first rounded portion and the second rounded portion, the corner being curved orthogonally from the planar surface of the blade,
wherein the first rounded portion curves orthogonally from the planar surface,
wherein the second rounded portion curves orthogonally from the planar surface and opposite from the first rounded portion,
wherein the blade is configured to secure to a top segment of a wire via a wire securing portion; and
the wire comprising:
the top segment comprising a wire cap secured on a first distal end of the top segment, the wire cap being configured to prevent linear translation of the blade along the length of the top segment,
a middle segment disposed between the top segment and a bottom segment, and
the bottom segment comprising:
a flexible curved portion disposed at a first distal end of the bottom segment and shaped such that a bell, in an “off” position, is secured within the flexible curved portion,
a hook assembly disposed at a second distal end of the bottom segment, and
the bell disposed, while in an “on” position, between the flexible curved portion and the hook assembly, the bell comprising a bell aperture allowing translational movement of the bell along the length of the bottom segment,
wherein in the “on” position, the blade is configured to contact the bell during a rotation of the blade.

19. The apparatus of claim 18, wherein the top segment comprises a ball disposed on a second distal end of the top segment.

20. The apparatus of claim 18, further comprising at least one protrusion on the planar surface.
